(19) United States
(12) Patent Application Publication
(10) Pub. No.: US 2013/0174055 A1
(43) Pub. Date: Jul. 4, 2013

(54) Content Related Viewer Voting Apparatus, Method and System

(71) Applicants: Erik J. Johnson, Dublin, CA (US); Jason B. Randell, Oakland, CA (US)

(72) Inventors: Erik J. Johnson, Dublin, CA (US); Jason B. Randell, Oakland, CA (US)

(21) Appl. No.: 13/339,546

(22) Filed: Dec. 29, 2011

(51) Int. Cl. G06F 3/01

(52) U.S. Cl. 715/753

(57) ABSTRACT

The disclosed CONTENT RELATED VIEWER VOTING APPARATUSES, METHODS AND SYSTEMS (“CRVV”) transform requests for votes in displayed consumable media via CRVV components into rewards for voter recruiting through social networking. In one embodiment, a computer-implemented method includes: receiving a request to vote in a content-related electronic voting opportunity from a user; providing, a voting opportunity page having at least one voting question and an expiration time; recording a content-related vote; providing a single-click opportunity to share the content-related vote and the voting opportunity via a social network; generating a social vote post message; receiving a vote from a peer of the user who accessed the social vote post message; and correlating the vote of the peer with the recorded content-related vote, to create a recruited vote total attributable to the user for each voting question.

### FIELD

The present innovations generally address apparatuses, methods, and systems for consumer engagement, and more particularly, include CONTENT RELATED VIEWER VOTING APPARATUS, METHOD AND SYSTEM (“CRVV”).

### BACKGROUND

Broadcasters provide consumable media to audiences, such as a television or radio audience. Some broadcasters may request feedback to the media from the audience. In some scenarios, the outcome of an event that is being broadcast may depend on the feedback provided by the audience, such as in reality programs or skills contests.

### BRIEF DESCRIPTION OF THE DRAWINGS

The accompanying appendices or drawings illustrate various non-limiting, example, inventive aspects in accordance with the present disclosure:

FIGS. 1A-B show block diagrams illustrating example aspects of content related viewer voting in some embodiments of the CRVV;

FIG. 2 shows a user interface diagram illustrating example features of a content related viewer voting interface in some embodiments of the CRVV;

FIGS. 3A-C show data flow diagrams illustrating an example social voter recruiting procedure in some embodiments of the CRVV;

FIGS. 4A-C show logic flow diagrams illustrating example aspects of social voter recruiting in some embodiments of the CRVV, e.g., a Social Voter Recruiting (“SVR”) component 400;

FIGS. 5A-B show data flow diagrams illustrating an example content related social voting procedure in some embodiments of the CRVV;

FIGS. 6A-B show logic flow diagrams illustrating example aspects of content related social voting in some embodiments of the CRVV, e.g., a Content Related Social Voting (“CRSV”) component 600;

FIGS. 7A-B show logic flow diagrams illustrating example aspects of analyzing user votes in some embodiments of the CRVV, e.g., a User Voting Analysis (“UVA”) component 700; and

FIG. 8 shows a block diagram illustrating embodiments of a CRVV controller.

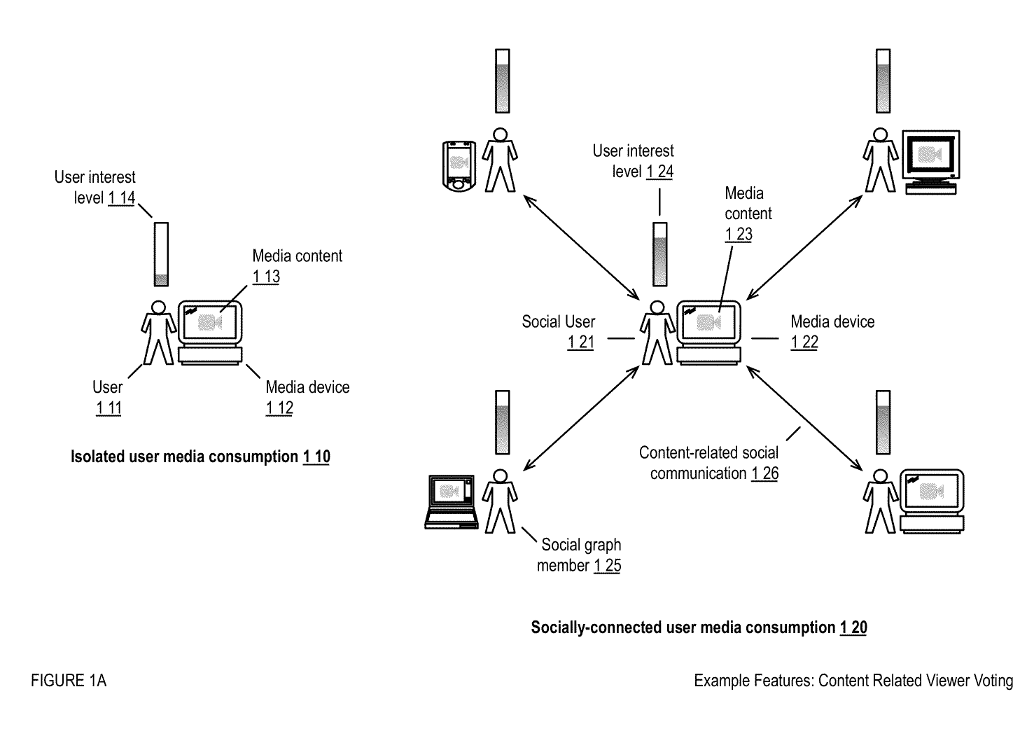

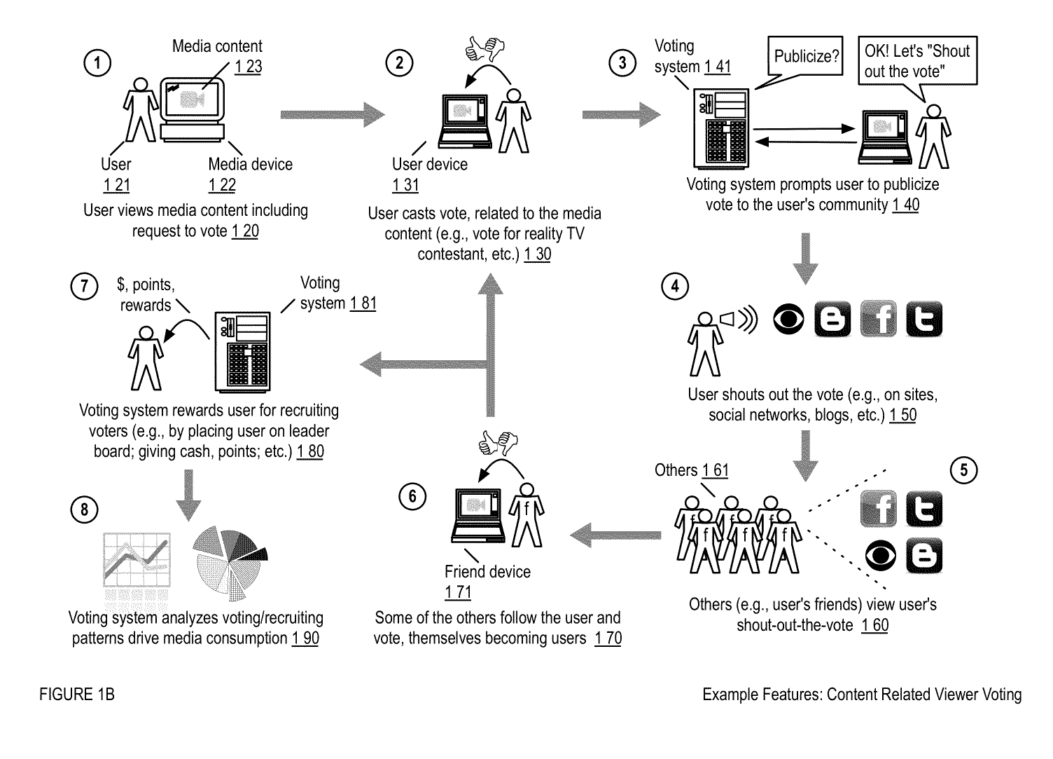

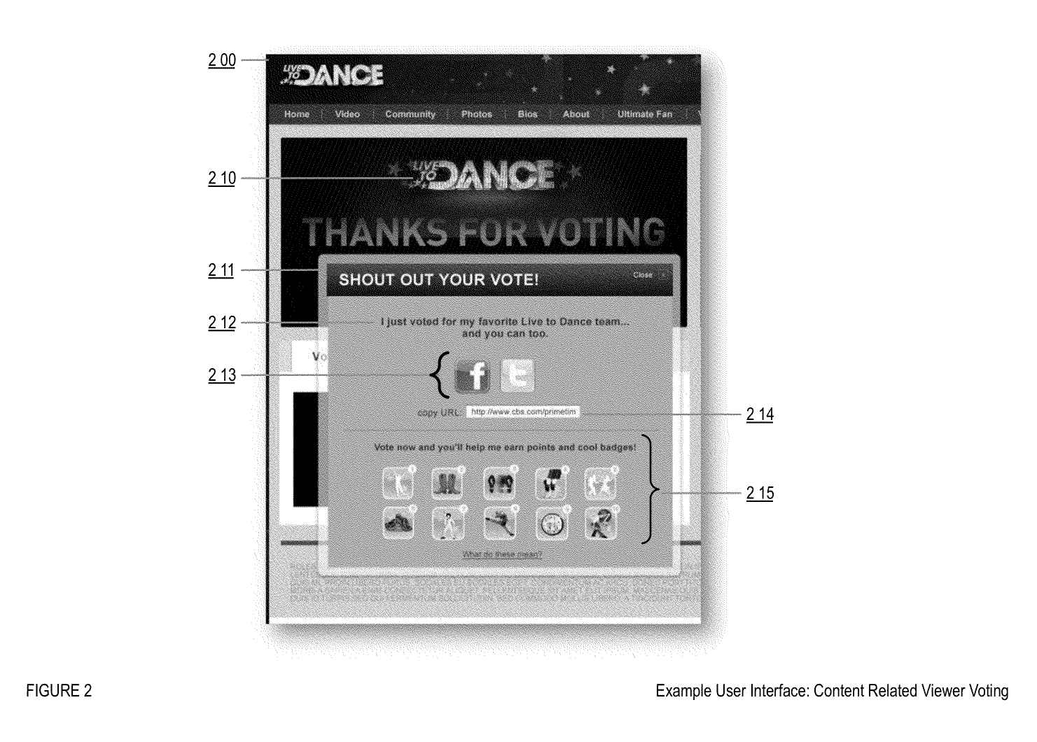

The leading number of each reference number within the drawings indicates the figure in which that reference number is introduced or detailed. As such, a detailed discussion of reference number 101 would be found or introduced in FIG. 1. Reference number 201 is introduced in FIG. 2, etc.

### DETAILED DESCRIPTION

### Content Related Viewer Voting (CRVV)

The CONTENT RELATED VIEWER VOTING APPARATUSES, METHODS AND SYSTEMS (hereinafter “CRVV”) transform requests for votes in displayed consumable media, via CRVV components, into rewards for voter recruiting through social networking. FIGS. 1A-B show block diagrams illustrating example aspects of content related viewer voting in some embodiments of the CRVV. With reference to FIG. 1A, in some embodiments, the CRVV may facilitate social interaction between consumers of media content to drive interest in the consumable media among the users. For example, a user 111 may be consuming media content 113 (e.g., program (sometimes colloquially referred to as “show”), contest, etc.) via a media device 112 (e.g., network-connected computer, television, radio, etc.). The user may be consuming the media content in isolation in some situations, e.g., 110. In such situations, the user may exhibit a sub-optimal interest level 114 in the media content. In contrast, in alternate situations, e.g., 120, a user 121 may engage in social interactions, e.g., 126, with other users. For example, the other users may be members of a social graph of the user (see e.g., 125). In such situations, the social user 121, consuming the media content 123 via a media device 122, may be at a user interest level 124 that is higher than the interest level 114 of a user consuming the media content in isolation. Accordingly, in some embodiments, the CRVV may attempt to increase the interest level of users in consumable media broadcast to the user by facilitating social interactions among the users. For example, the CRVV may utilize social networks to facilitate social interactions among users that lead to increasing interest in consumable media broadcasts.

With reference to FIG. 1B, in some embodiments, a user 121 may consume (e.g., view, listen to) media content 123 (e.g., reality TV program, singing/popularity contest) via a media device 122 (e.g., television, radio, desktop computing device, mobile computing device, etc.), wherein the media content includes a request to vote 120. For example, the media content may include a request to: dial a phone number to cast a vote; send a text/e-mail message including voting preferences; navigate to a website to cast a vote; vote via an application installed on a device (e.g., the media device 122); send a message on a social networking service; or the like. In response to the request to vote embedded in the media content, the user may cast a vote 130 related to the media content, via a voting system. In some embodiments, the voting system may prompt the user to Shout Out The Vote™ (Shout Out The Vote™, CBS®, or other trademarks used herein are property of CBS, Inc. Other marks as used herein are property of their respective owners, and are not used to indicate the nature or quality of goods or services so marked or generically). For example, the voting system may prompt the user to publicize the user's vote to the user's community 140. The user may utilize features provided by the voting system to then Shout Out The Vote™ to the user's community 150, e.g., via a blog (e.g. on blogger.com), social networking service (e.g., Facebook®, Twitter™, etc.), webpage, website related to the media content provided to the user (e.g., CBS.com), etc. In some embodiments, others 161 (e.g., the user's friends) may view the user's Shout Out The Vote™ 160, and some of the others may follow the user and vote by, for example, using their own devices 171, in the process themselves becoming users of the voting system 170, as well as, preferably, being considered “recruits” of the original user by the voting system.

In some embodiments, the voting system 181 may reward its users for recruiting other users by assigning credits, points, etc., for each recruit the user brings to the voting system 180. In some embodiments, the voting system may maintain and provide a recruiting leaderboard indicating the relative recruiting performance of various users, or for groups with which the users are affiliated. For example, a user may be affiliated with one or more groups (e.g., a red or blue team on a hypothetical program called “The Great Race”), and for each voter that the user recruits to the voting system, both the user and the user's affiliated groups may be assigned credits, points, etc. by the voting system. In some embodiments, the assignment and amount of rewards to a user-affiliated group may depend on a membership level of the user within the affiliated group. Thus, in some embodiments, only users, only groups, or both users and user groups may be listed on a recruiting leaderboard within the voting system. In some embodiments, the voting system may analyze voting patterns of users, and recruiting patterns of the users 190. The voting system may utilize the voting and recruiting patterns to identify demographics and preferences of various users, which may be used in tailoring the broadcast media content to further drive media consumption. For example, the voting and recruiting patterns may be used for targeted advertisements, programming content selection, reality TV contestant selection, re-run content selection, selection of interactive programming elements, informing new production of future shows/episodes, adaptively modifying the voting process and rewards mechanisms of the voting system, identifying social mechanisms for increasing media consumption, and various other optimizations in various embodiments of the CRVV.

FIG. 2 shows a user interface diagram illustrating example features of a content related viewer voting interface in some embodiments of the CRVV. In some embodiments, the CRVV may provide users with a voting interface via which the users may cast their vote into the voting system. Here, providing a voting interface may include, without limitation: transmitting a web page; transmitting data that may trigger building of a webpage on a user device; transmitting a resource locator to a webpage; allowing access to a webpage; granting a key or password to access a webpage; etc. In some embodiments, the voting interface may be a web-based interface displayed to the user via a browser executing on a client operated by the user. The browser may display a webpage 200 including an identifier of media content 210 related to which the user can cast a vote. The webpage may also include buttons, sliders, text boxes, radio buttons or other graphical input elements via which the user may cast votes and select relative preferences among various vote options. In some embodiments, the CRVV may provide a pop-up window, lightbox, frame, or other like graphical user interface 211 in response to the user submitting votes. The graphical user interface may provide messages that can be used by the user to shout out the vote 212, 215. For example, the messages may describe aspects of the voting process that user's recruits may find interesting, and may includes motivational messages for why the user's recruits should vote. In some embodiments, the graphical user interface may also provide graphical elements (such as buttons, radio buttons, check boxes or the like), which the user can activate to shout out the votes (e.g., via social networking sites such as Facebook® or Twitter™, blogs such as on blogger.com, sites such as CBS.com, or the like). In some embodiments, the graphical user interface may provide a text-selectable hyperlink 214 to the voting page, which the user can copy and utilize anywhere the user likes. Using mechanism such as the ones described above, the CRVV may enable the user to shout out the votes to a broad range of communities.

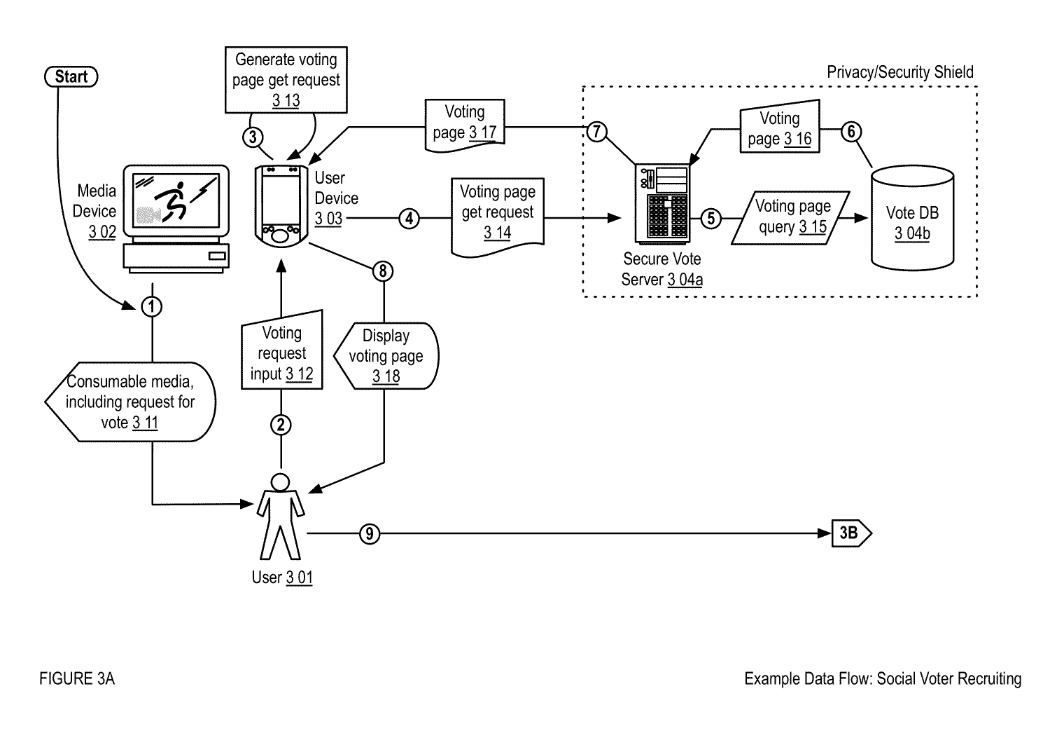

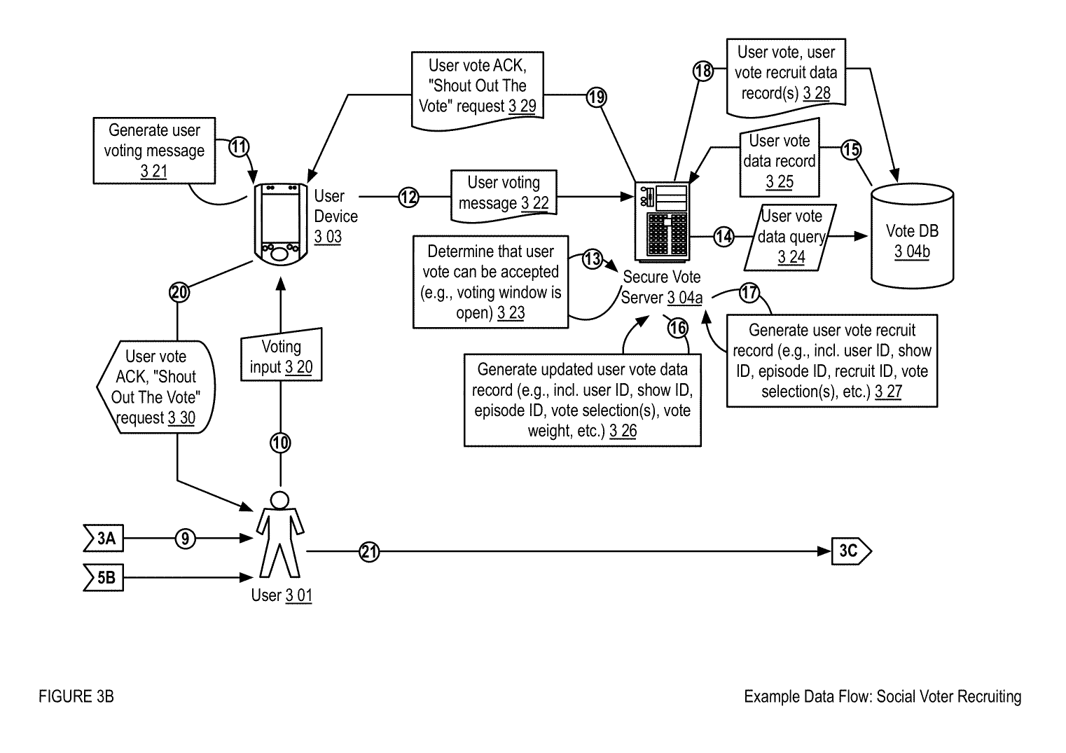

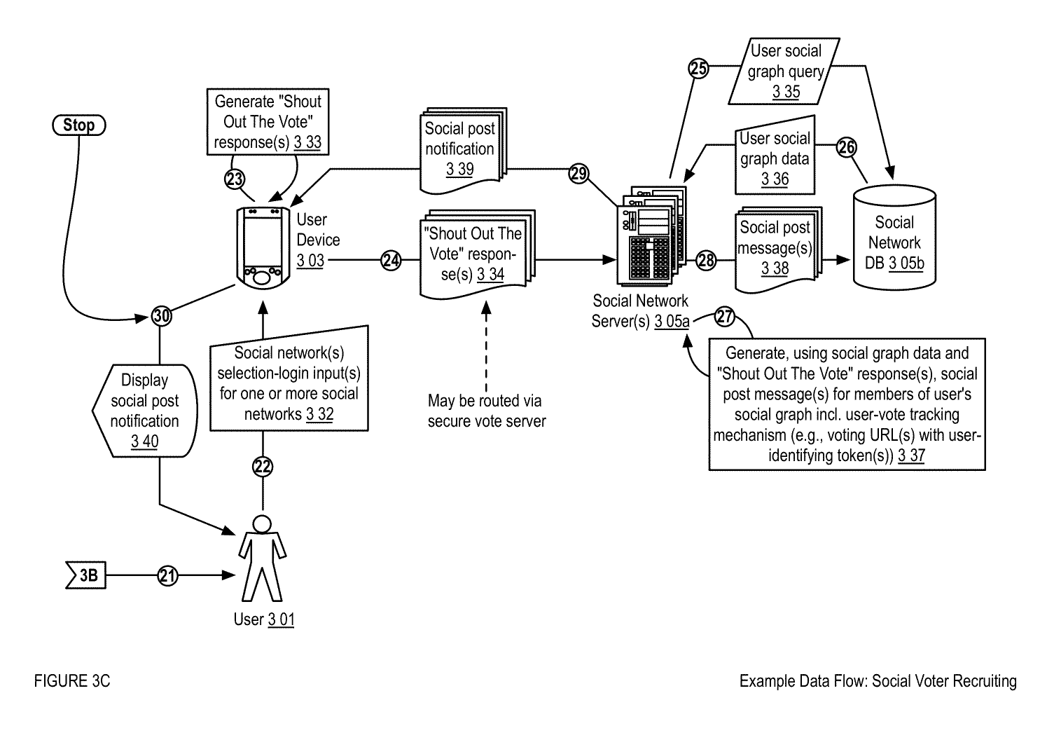

FIGS. 3A-C show data flow diagrams illustrating embodiments of a social voter recruiting procedure of the CRVV. With reference to FIG. 3A, a user 301 may view consumable media content 311 (e.g., reality TV program, singing/popularity contest) via a media device 302 (e.g., network-connected computing device, television, radio). In some embodiments, the user may also be utilizing a user device 303. In some embodiments, the user device 303 (e.g., a mobile computing device) may be included in the media device 302. For example, the user may be viewing Internet-streamed media via a browser application that is executing on a network-connected computer and includes a voting console, or the user may be viewing a television display that provides a voting console. The media content may include a request to vote 311 (e.g., via a computing device, telephone, communication device, etc.). In some embodiments, in response to the request to vote embedded in the media content, the user may provide a voting request input 312 to the user device 303 to obtain a voting site where the user can cast a vote. For example, the voting request input 312 may include, but not be limited to: a gesture on a touch-sensitive interface, a keyboard entry, a card swipe, activating a RFID/NFC-enabled hardware component within the user device 303, mouse clicks, activating a joystick/game console, voice commands, providing commands via a motion sensitive device (e.g., Microsoft® Kinect), or the like. In response to the user's voting request input, the user device may generate a voting page get request 313, and provide the voting page get request 314 to a secure vote server 304a. For example, the user device 303 may provide the request to the secure vote server as a HTTP(S) POST message including XML-formatted data. An example listing of a voting page get request 314, substantially in the form of a HTTP(S) POST message including XML-formatted data, is provided below:

```
POST /voting_page_get_request.php HTTP/1.1
Host: www.securevoteserver.com
Content-Type: Application/XML
Content-Length: 449
<?XML version = “1.0” encoding = “UTF-8”?>
<get_request>
  <request_id>AFYUD09876</request_id>
  <timestamp>2011-05-05 12:34:44</timestamp>
  <media_data>
    <media_id>XYZ-ABC-2011-02-02</media_id>
  </media_data>
  <user_data>
    <user_id>john.q.public@vote.com</user_id>
    <password>GJHS%#@$% [symbol]   &*( )JB</password>
  </user_data>
  <client_fingerprint>
    <client_ip>192.168.1.101</client_ip>
    <client_type>mobile</client_type>
    <client_OS>Android 2.2</client_OS>
    <application>chrome 7.1.12</application>
  </client_fingerprint>
</get_request>
```

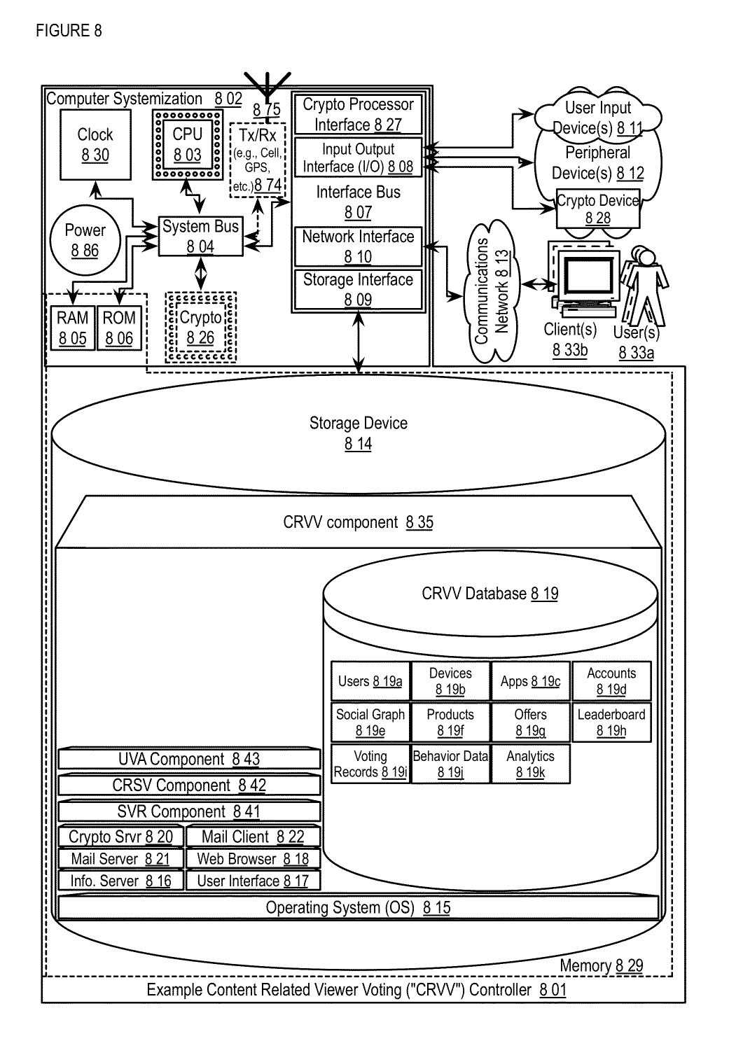

In some embodiments, the secure vote server may require the user to log in before servicing the user's voting page get request. The secure vote server may parse the voting page get request, and extract data on the media content and user client from the voting page get request. Using the extracted data, the secure vote server may generate a voting page query 315, and provide the voting page query to a vote database 304b. For example, the secure vote server may issue PHP/SQL commands to query a database table (such as FIG. 8, Apps 819c) for a voting page or voting app (e.g., Javascript™, Adobe® Flash, etc.). An example voting page query 315, substantially in the form of PHP/SQL commands, is provided below:

<?PHP
header(‘Content-Type: text/plain’);
mysql_connect(“254.93.179.112”,$DBserver,$password); // access database server
mysql_select_db(“CRVV_DB.SQL”); // select database table to search
//create query
$query = “SELECT app_script FROM AppsTable WHERE media_id LIKE ‘%’ $mediaid”;
$result = mysql_query($query); // perform the search query
mysql_close(“CRVV_DB.SQL”); // close database access
?>

In response to the query, the vote database 304b may provide a voting page or voting application (e.g., a software application, module, script, code snippet). The secure vote server may provide the voting page retrieved from the vote database to the user device. For example, the secure vote server may provide a code listing similar to the example code listing provided below as the voting page 317:

```
<html>
  <body>
      <script type=“text/javascript”
    src=“http://secure.vote.com/js/votingapp.js”></script>
      <script type=“text/javascript”>
      var securevoteparams = {
```

| | |
|---|---|
| “mediaid” | : “XYZ-ABC-2011-02-02”, |
| “userid” | : “john.q.public@vote.com”, |
| “hash” | : “df659d502af5151a2edd18e2ebb50ba3”, |
| “xdurl” | : “http://www.mydomain.com/xd.html” |

```
      }
      function showVotingapp( )
      </script>
      <a href=“javascript:showVotingapp( );”>Vote Now</a>
      <div id=“div_b” style=“display:none;padding:10px;position:
      absolute;top:
    50%;left: 50%; margin-top: −212px; margin-left: −351px;”></div>
  </body>
</html>
```

It is to be understood that other methods of facilitating user voting could also function as desired. For example, the CRVV may facilitate the user casting votes via sending text messages, sending electronic mails, posting messages to a social networking website, posting a message to a blog (or in the comments section of a blog), sending a fax message, placing a telephone call, or the like. In some embodiments, the user device may display the voting page for the user.

With reference to FIG. 3B, in some embodiments, in response to viewing the voting page displayed by the user device, the user may enter a voting input into the user device. For example, the voting input may include, but not be limited to: a gesture on a touch-sensitive interface, a keyboard entry, a card swipe, activating a RFID/NFC-enabled hardware component within the user device, mouse clicks, activating a joystick/game console, voice commands, providing commands via a motion sensitive device (e.g., Microsoft® Kinect), or the like. In response to the user's voting input, the user device may generate, e.g., 321, a user voting message 322, and provide the user voting message to the secure vote server. For example, the user device 303 may provide the user voting message to the secure vote server as a HTTP(S) POST message including XML-formatted data. An example listing of a user voting message 322, substantially in the form of a HTTP(S) POST message including XML-formatted data, is provided below:

```
POST /voting_message.php HTTP/1.1
Host: www.securevoteserver.com
Content-Type: Application/XML
Content-Length: 449
<?XML version = “1.0” encoding = “UTF-8”?>
<voting_message>
  <message_id>AFYUD09876</request_id>
  <timestamp>2011-05-05 12:34:44</timestamp>
  <vote_data>
    <media_id>XYZ-ABC-2011-02-02</media_id>
    <vote>
      <1><object_id>A123</object_id></1>
      <2><object_id>B098</object_id></2>
      <3><object_id>H768</object_id></3>
    </vote>
  </vote_data>
  <user_data>
    <user_id>john.q.public@vote.com</user_id>
    <password>GJHS%#@$% [symbol]   &*( )JB</password>
  </user_data>
  <client_fingerprint>
    <client_ip>192.168.1.101</client_ip>
    <client_type>mobile</client_type>
    <client_OS>Android 2.2</client_OS>
    <application>chrome 7.1.12</application>
  </client_fingerprint>
</get_request>
```

In some embodiments, the secure vote server may parse the voting message and extract data on the user and the user's vote from the voting message. Using the extracted data, the secure vote server may determine whether the user vote can be accepted. For example, the secure vote server may determine whether the vote data is valid, whether the vote was submitted within the appropriate time window for the particular media related to the user's vote, whether the user has sufficient permissions to cast the particular vote, or the like. Upon determining that the user vote can be accepted, the secure vote server may generate a user vote data query 324, and provide the voting page query to the vote database 304b. For example, the secure vote server may issue PHP/SQL commands to query a database table (such as FIG. 8, Voting Records 819i) for a user vote data record. An example user vote data query 324, substantially in the form of PHP/SQL commands, is provided below:

<?PHP
header(‘Content-Type: text/plain’);
mysql_connect(“254.93.179.112”,$DBserver,$password); // access
database server
mysql_select_db(“CRVV_DB.SQL”); // select database table to search
//create query
$query = “SELECT vote_id media_id vote_selection_list FROM
VotingRecordsTable
WHERE user_id LIKE ‘%’ $userid”;
$result = mysql_query($query); // perform the search query
mysql_close(“CRVV_DB.SQL”); // close database access
?>

In response to the query, the vote database 304b may provide a user vote data record 325. The secure vote server may parse the user vote data record and extract the data included in the user vote data record. Using the data extracted from the user vote data record and the user voting message, the secure vote server may generate 326 an updated user vote data record. The updated user vote data record may include fields such as, but not limited to: user ID, media ID, show ID, episode ID, vote selections, vote weights, lists of affiliated groups for particular votes, or the like. In some embodiments, the secure vote server may generate 327 a user vote recruit record to track recruiting statistics associated with the user. For example, the user vote recruit record may include fields such as, but not limited to: user ID, recruit ID, media ID, show ID, episode ID, vote selections, vote weights, lists of affiliated groups for particular votes, or the like. The secure vote server may store 328 the updated user vote data record and user vote recruit record in the vote database. For example, the secure vote server may issue PHP/SQL commands to store the data to a database table (such as FIG. 8, Voting Records 819i). An example voting data record store command 328, substantially in the form of PHP/SQL commands, is provided below:

```
<?PHP
header(‘Content-Type: text/plain’);
mysql_connect(“254.92.185.103”,$DBserver,$password); // access
database server
mysql_select(“CRVV_DB.SQL”); // select database to append
mysql_query(“INSERT INTO VotingRecordsTable (user_ID,
media_ID, show_ID,
  episode_ID, vote_selection_list, vote_weight_list, affiliated_group_list)
VALUES ($user_ID, $media_ID, $show_ID, $episode_ID,
$vote_selection_list,
  $vote_weight_list, $affiliated_group_list)”); // add data to table in
  database
mysql_close(“CRVV_DB.SQL”); // close connection to database
?>
```

In some embodiments, the voting system may prompt 329 the user to Shout Out The Vote™. For example, the voting system may prompt the user to publicize the user's vote to the user's community. The secure vote server may provide the Shout Out The Vote™ request to the user device as a HTTP(S) POST message including XML-formatted data, similar to the examples described previously. The user device may display the Shout Out The Vote™ request to the user.

With reference to FIG. 3C, in some embodiments, the user may utilize features provided by the secure voting server to Shout Out The Vote™ to the user's community, e.g., via a blog (e.g. on blogger.com), social networking service (e.g., Facebook®, Twitter™, etc.), webpage, website related to the media content provided to the user (e.g., CBS.com), etc. The user may provide social network/site selection and login inputs to the user device, so as to Shout Out The Vote™ to one or more publications. For example, the user input may include, but not be limited to: a gesture on a touch-sensitive interface, a keyboard entry, a card swipe, activating a RFID/NFC-enabled hardware component within the user device, mouse clicks, activating a joystick/game console, voice commands, providing commands via a motion sensitive device (e.g., Microsoft® Kinect), or the like. For each selected publication site, the user device may generated Shout Out The Vote™ responses 333 using the user selection-login inputs. The user device may send the generate Shout Out The Vote™ responses 334 to each of the selected publication sites, e.g., social network server(s) 305a. For example, the user device may provide the Shout Out The Vote™ responses to the social network server(s) as HTTP(S) POST messages including XML-formatted data, similar to the examples described previously. The social network servers may query 335 social network database 305b to obtain user social graph data 336. Using the user social graph data, the social network server(s) may generate social post message(s) 337 for members of the user's social graph. In some embodiments, the social post messages may include a user-vote tracking mechanism to track votes that were recruited by the user. For example, the social post message may include a hyperlink to a voting page, wherein the hyperlink includes user ID variables, such as a token uniquely associated with the user, that may be passed to the secure vote server when a recruited voter clicks on the link. An example, hyperlink code listing is provided below:

```
<html>
  <body>
    <a href=“https://www.vote.com/vote.php?track=12345678”>Vote
    Now!</a>
  </body>
</html>
```

Such tokens may be generated by a variety of methods. In some embodiments, the tokens may be randomly generated, and the token value may be stored in a user profile record in a database that the secure vote server can access. In alternate embodiments, the token may be generated by performing an MD5 hash encryption of data uniquely associated with the user (such as a user ID, username, etc.) and/or other data (such as a timestamp associated with the user registering with the secure vote server, a timestamp associated with the recruiting voter casting a vote with the secure vote server, etc.). In alternate embodiments, the token value may be assigned by a user (e.g., recruiting user, recruited user, etc.).

In some embodiments, the secure vote server may store 338 the social post messages in the social network database for later presentation to members of the user's social graph. In some embodiments, the secure vote server may provide a social post notification 339 to the user device indicating successful posting of the Shout Out The Vote™ to the user's community. The user device may display 340 the social post notification for the user.

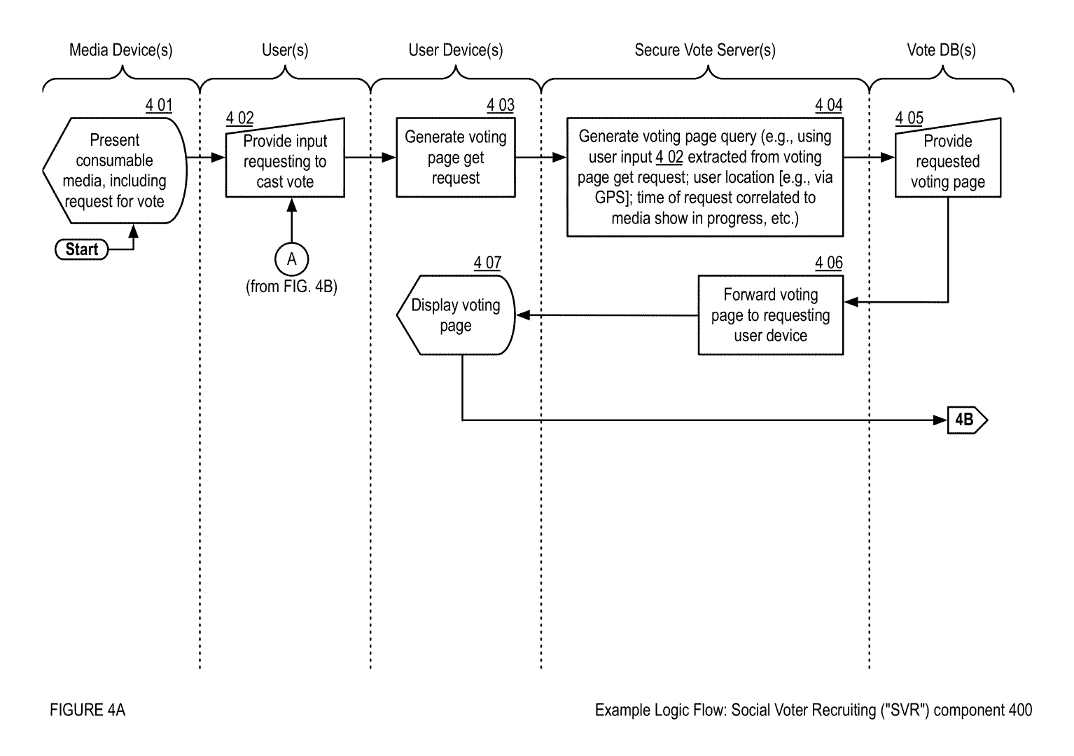

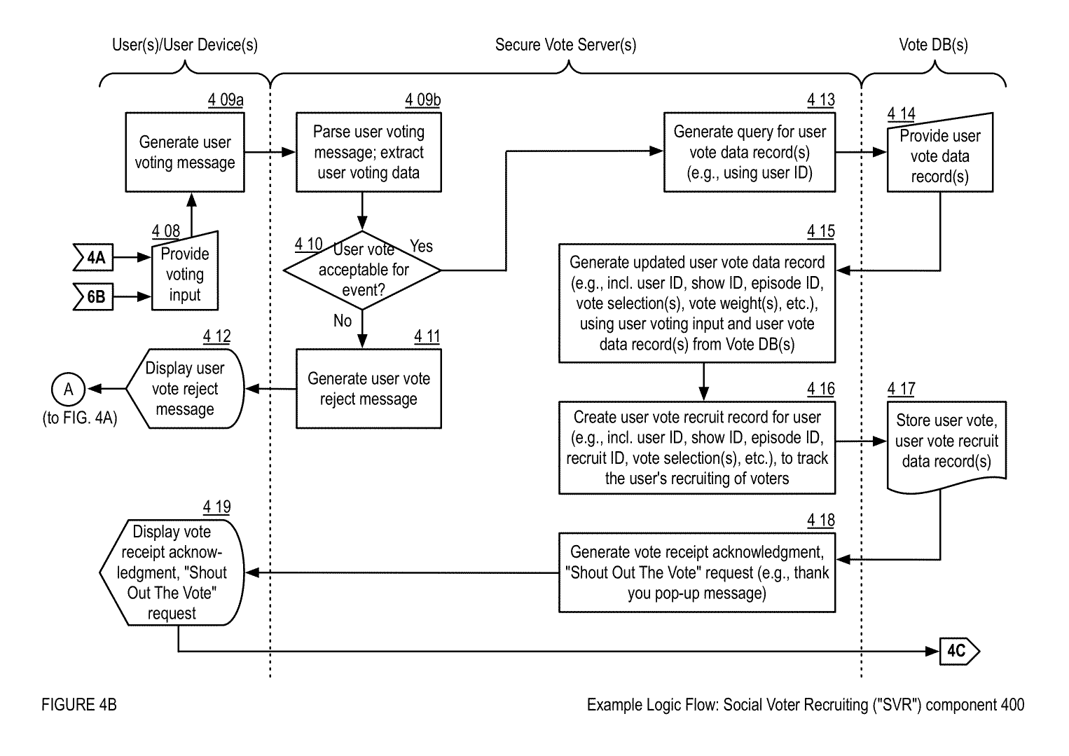

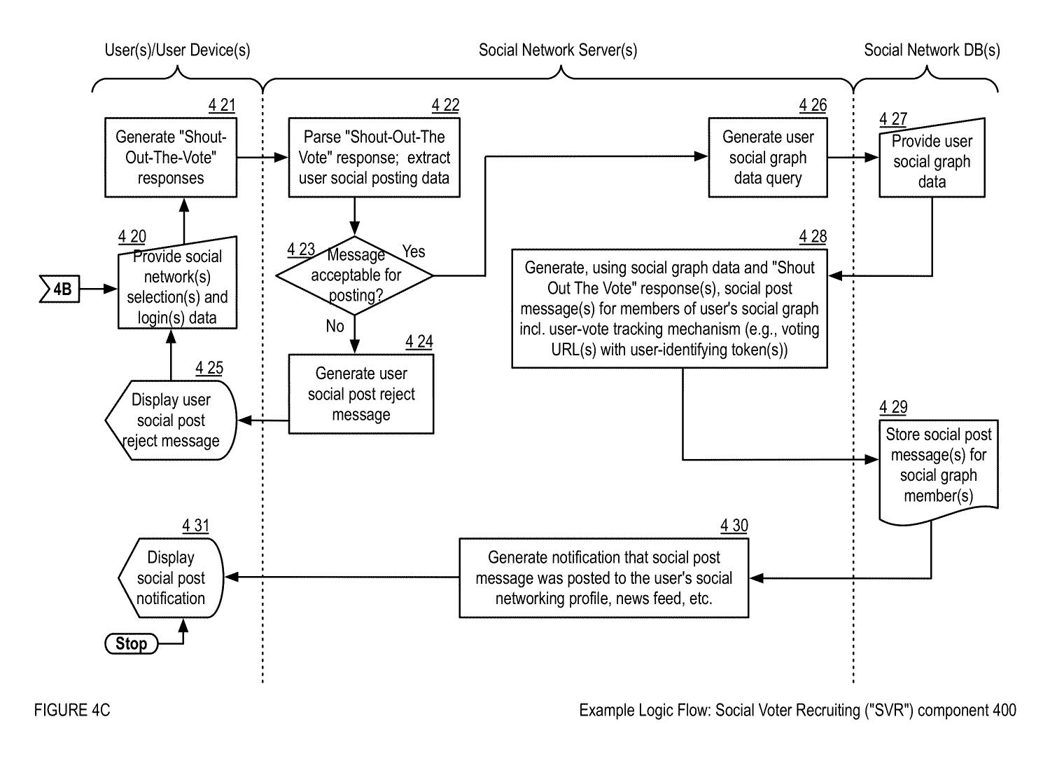

FIGS. 4A-C show logic flow diagrams illustrating example aspects of social voter recruiting in some embodiments of the CRVV, e.g., a Social Voter Recruiting (“SVR”) component 400. With reference to FIG. 4A, in some embodiments, a media device (e.g., network-connected computer, television, radio, mobile computing device) may present a user with consumable media content (e.g., reality TV program, singing/popularity contest), 401. In some embodiments, the user also may be utilizing a user device. In some embodiments, the user device may be included in the media device. As examples, the user may be viewing Internet-streamed media via a browser application that is executing on a network-connected computer and includes a voting console; or the user may be viewing a display of a television or computing device, and utilizing a separate device (e.g., remote control, computing device with a standalone or web application, telephone, fax machine, etc.) that provides a voting mechanism. The media content may include an encouragement to vote online. In some embodiments, in response to the encouragement to vote embedded in the media content, the user may provide a voting request input to the user device to obtain a voting site where the user can cast a vote, 402. In response to the user's voting request input, the user device may generate a voting page get request, 403, and provide the voting page get request to a secure vote server. In some embodiments, the secure vote server may require the user to log in before servicing the user's voting page get request. The secure vote server may parse the voting page get request, and extract data on the media content and user client from the voting page get request. Using the extracted data, the secure vote server may generate a voting page query, and provide the voting page query to a vote database, 404. For example, the secure vote server may identify a location of the user (e.g., using GPS, IP address, time zone, etc.), a timestamp for the user voting page get request. In some embodiments, the secure vote server may correlate the timestamp and location of the user, to media programs currently in progress, and thereby identify media content related to the user's voting page get request. Using the identified media content, user location, user ID, timestamp or other available data, the secure vote server may query the vote database. In response to the query, the vote database may provide a voting page or voting app, 405. The secure vote server may provide the voting page retrieved from the vote database to the user device, 406. In some embodiments, the user device may display the voting page for the user, 407.

With reference to FIG. 4B, in some embodiments, in response to viewing the voting page displayed by the user device, the user may provide a voting input into the user device, 408. In response to the user's voting input, the user device may generate a user voting message, and provide the user voting message to the secure vote server, 409a. In some embodiments, the secure vote server may parse the voting message, and extract data on the user and the user's vote from the voting message 409b. Using the extracted data, the secure vote server may determine whether the user vote can be accepted, 410. For example, the secure vote server may determine whether the vote data is valid, whether the vote was submitted within the appropriate time window for the particular media related to the user's vote, whether the user has sufficient permissions to cast the particular vote, or the like. If the secure vote server determines that the vote data is not valid, 410 (option “No”), the secure vote server may generate a “user vote reject” message, and provide the message to the user device, 411. The user device may display the “user vote reject” message to the user, 412.

In some embodiments, upon determining that the user vote can be accepted, 410 (option “Yes”), the secure vote server may generate a user vote data query, and provide the voting page query to the vote database 413. In response to the query, the vote database may provide a user vote data record, 414. The secure vote server may parse, the user vote data record, and extract the data included in the user vote data record. Using the data extracted from the user vote data record and the user voting message, the secure vote server may generate an updated user vote data record, 415. The updated user vote data record may include fields such as, but not limited to: user ID, media ID, show ID, episode ID, vote selections, vote weights, lists of affiliated groups for particular votes, or the like. In some embodiments, the secure vote server may generate a user vote recruit record to track recruiting statistics associated with the user, 416. For example, the user vote recruit record may include fields such as, but not limited to: user ID, recruit ID, media ID, show ID, episode ID, vote selections, vote weights, lists of affiliated groups for particular votes, or the like. The secure vote server may store the updated user vote data record and user vote recruit record in the vote database, 417. In some embodiments, the voting system may prompt the user to Shout Out The Vote™, 418. For example, the voting system may prompt the user to publicize the user's vote to the user's community. The secure vote server may provide the Shout Out The Vote™ request to the user device, 418. The user device may display the Shout Out The Vote™ request to the user, 419.

With reference to FIG. 4C, in some embodiments, the user may utilize features provided by the secure voting server to Shout Out The Vote™ to the user's community, e.g., via a blog (e.g. on blogger.com), social networking service (e.g., Facebook®, Twitter™, etc.), webpage, website related to the media content provided to the user (e.g., CBS.com), etc. The user may provide social network/site selection and login inputs to the user device, so as to Shout Out The Vote™ to one or more publications, 420. For each selected publication, the user device may generate Shout Out The Vote™ responses using the user selection-login inputs, 421. The user device may send the generated Shout Out The Vote™ responses to each of the selected publication sites, e.g., social network server(s). The social network server may parse the received Shout Out The Vote™ responses, and extract user social posting data from the responses, 422. The social network server may determine whether the messages are acceptable for posting, 423. For example, the social network servers may determine whether the messages satisfy size constraints, language constraints, constraints on explicitness of language or other rules that the social network servers may impose. If the social network servers determine that the messages are not acceptable for posting, 423 (option “No”), the secure vote server may generate a “user social post reject” message, and provide the message to the user device, 424. The user device may display the “user social post reject” message to the user, 425.

In some embodiments, upon determining that the user social post messages can be accepted, 423 (option “Yes”), the secure vote server may query their social network databases to obtain user social graph data, 426-427. Using the user social graph data, the social network server(s) may generate social post message(s) for members of the user's social graph, 428. In some embodiments, the social post messages may include a user-vote tracking mechanism to track votes that were recruited by the user. For example, the social post message may include a hyperlink to a voting page, wherein the hyperlink includes user ID variables that may be passed to the secure vote server when a recruited voter clicks on the link. The secure vote server may store the social post messages in the social network database for later presentation to members of the user's social graph, 429. In some embodiments, the secure vote server may generate and provide a social post notification to the user device indicating successful posting of the Shout Out The Vote™ to the user's community, 430. The user device may display the social post notification for the user, 431.

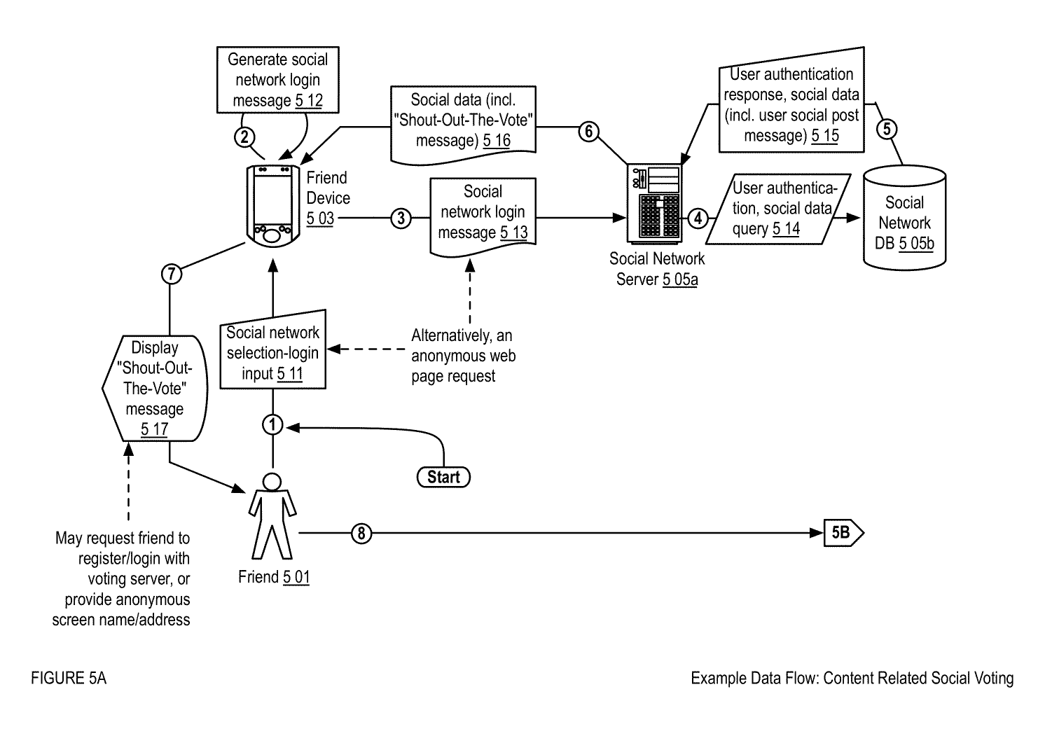

FIGS. 5A-B show data flow diagrams illustrating an example content related social voting procedure in some embodiments of the CRVV. With reference to FIG. 5A, in some embodiments, others (e.g., a voting user's friends) may view the user's Shout Out The Vote™. For example, a friend 501 may utilize a friend device 503 to view social data from a social network server 505a. The friend may provide social network/site selection and login inputs 511 to the friend device. The friend device may generate a social network login message 512 using the user selection-login inputs. The friend device may send the generated social network login message 513 to social network server 505a. The social network server may parse the received social network login message, and extract user authentication data from the message. The social network server may query 514 a social network database 505b to determine whether the user is authenticated. In response, the social network database may provide a user authentication response 515, and if authenticated, may also provide social data for presentation to the friend including the Shout Out The Vote™ message from a voting user (see, e.g., FIG. 3C, elements 333-338) who is socially related to the friend 501. The social network server may provide the Shout Out The Vote™ message from the user to the friend device, 516. The friend device may present the user's Shout Out The Vote message to the friend, 517.

With reference to FIG. 5B, in some embodiments, the friend 501 may cast votes with the voting system, in the process becoming a user of the voting system, as well as being considered a “recruit” of the original user by the voting system. For example, the friend 501 may provide a voting input into the friend device 519. For example, the voting input may include, but not be limited to: a gesture on a touch-sensitive interface, a keyboard entry, a card swipe, activating a RFID/NFC-enabled hardware component within the user device, mouse clicks, activating a joystick/game console, voice commands, providing commands via a motion sensitive device (e.g., Microsoft® Kinect), or the like. In response to the friend's voting input, the friend device may generate a voting message 520, and provide the voting message to the secure vote server 504a. For example, the friend device 503 may provide the voting message to the secure vote server as a HTTP(S) POST message including XML-formatted data. An example listing of a voting message 520, substantially in the form of a HTTP(S) POST message including XML-formatted data, is provided below:

```
POST /voting_message.php HTTP/1.1
Host: www.securevoteserver.com
Content-Type: Application/XML
Content-Length: 449
<?XML version = “1.0” encoding = “UTF-8”?>
<voting_message>
  <message_id>AFYUD09876</request_id>
  <recruit_token>1324978647532</recruit_token>
  <timestamp>2011-05-05 12:34:44</timestamp>
  <vote_data>
    <media_id>XYZ-ABC-2011-02-02</media_id>
    <vote>
      <1><object_id>A123</object_id></1>
      <2><object_id>B098</object_id></2>
      <3><object_id>H768</object_id></3>
    </vote>
  </vote_data>
  <user_data>
    <user_id>jane.p.doe@vote.com</user_id>
    <password>dfjkhs47& [symbol]   &% [symbol]   12</password>
  </user_data>
  <client_fingerprint>
    <client_ip>192.168.1.101</client_ip>
    <client_type>mobile</client_type>
    <client_OS>Android 2.2</client_OS>
    <application>chrome 7.1.12</application>
  </client_fingerprint>
</get_request>
```

In some embodiments, the secure vote server may parse the voting message, and extract data on the friend and the friend's vote from the voting message. Using the extracted data, the secure vote server may determine whether the friend vote can be accepted. For example, the secure vote server may determine whether the vote data is valid, whether the vote was submitted within the appropriate time window for the particular media related to the user's vote, whether the friend has sufficient permissions to cast the particular vote, or the like. Upon determining that the friend vote can be accepted, the secure vote server may generate a friend vote data query, and provide the voting page query to the vote database 504b. In response to the query, the vote database 504b may provide a friend vote data record. The secure vote server may parse, the friend vote data record, and extract the data included in the friend vote data record. Using the data extracted from the friend vote data record and the voting message, the secure vote server may generate an updated friend vote data record.

In some embodiments, the voting system may reward its users for recruiting other users by assigning credits, points, etc., for each recruit the user brings to the voting system. In some embodiments, the voting system may maintain and provide a recruiting leaderboard indicating the relative recruiting performance of various users, or for groups that users are affiliated in. For example, a user may be affiliated with one or more groups (e.g., a red or blue team on “The Great Race” TV program), and for each voter that the user recruits to the voting system, both the user and the user's affiliated groups may be assigned credits, points, etc. by the voting system. In some embodiments, the assignment and amount of rewards to a user-affiliated group may depend on a membership level of the user within the affiliated group. Thus, in some embodiments, only users, only groups, or both users and user groups may be listed on a recruiting leaderboard within the voting system.

In some embodiments, the secure vote server may parse 521 the vote message 520, and extract any tokens identifying one or more recruiting users or user groups who (were in the chain of users or groups that) recruited the friend 501 to vote with the voting system. Using the extracted token, the secure vote server may query 522 a vote database 504b for a user ID of the recruiting users or groups involved in recruiting the friend 501 to the voting system. In response, the vote database may provide a list of recruiting users and groups 523. In some embodiments, for each recruiting user, the secure vote server may identify a list of groups affiliated to the user. In addition to the (independent) recruiting groups, the secure vote server may reward (dependent) groups affiliated to recruiting users, in some embodiments. For example, the secure vote server may query the vote database for user groups affiliated to each recruiting user that can be rewarded for the user's efforts in recruiting the friend 501 to the voting system 524. For example, a subset of the user's affiliated groups may be rewarded depending on the user's preferences as to which of the user's affiliated groups should be rewarded, the membership level of the user within each of the user's affiliated groups, or the like. The vote database may provide a list of the user's affiliated groups that can be so rewarded 525, in response to the creditable user group query 524.

In some embodiments, using the above data, the secure vote server may determine 526, for each identified recruiting or recruiter-affiliated user or group, a type and amount of credit to assign for recruiting the friend 501 to the voting system. The secure vote server may also determine the position of each user or group in each leaderboard in which they may appear. In some embodiments, the secure vote server may determine whether any of the users or groups qualify for an award (e.g., virtual currency, cash prize, badges, publicity, etc.). In various embodiments, a wide range of awards similar to the above may be determined by the secure vote server for each of the users or groups who can be rewarded for assisting in recruiting the friend 501 to the voting system. The secure vote server may store 527 the updated credits, leaderboard, awards and other data to the vote database. In some embodiments, the secure vote server may redirect the friend 501 to the Shout Out The Vote™ process, such as described above with reference to FIG. 3C. The secure voter server may generate and provide a Shout Out The Vote™ request 528 to the friend device 503, which may in turn present 529 the Shout Out The Vote Request to the friends 503 (who may become equivalent to user 301 in FIG. 3C in some embodiments).

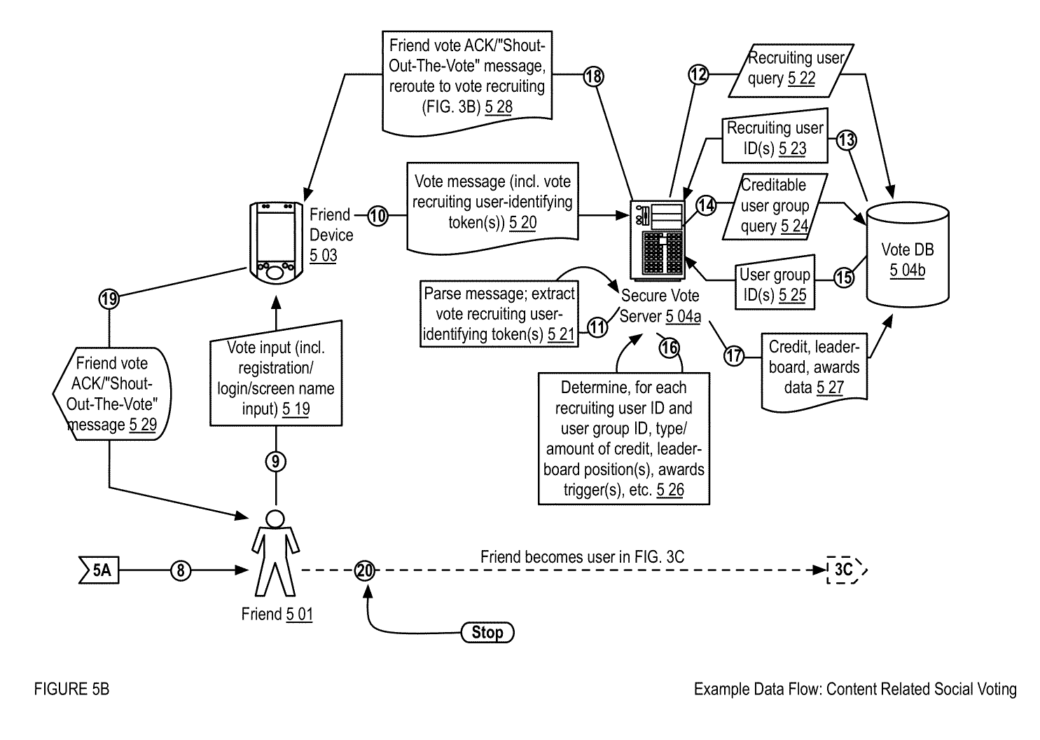

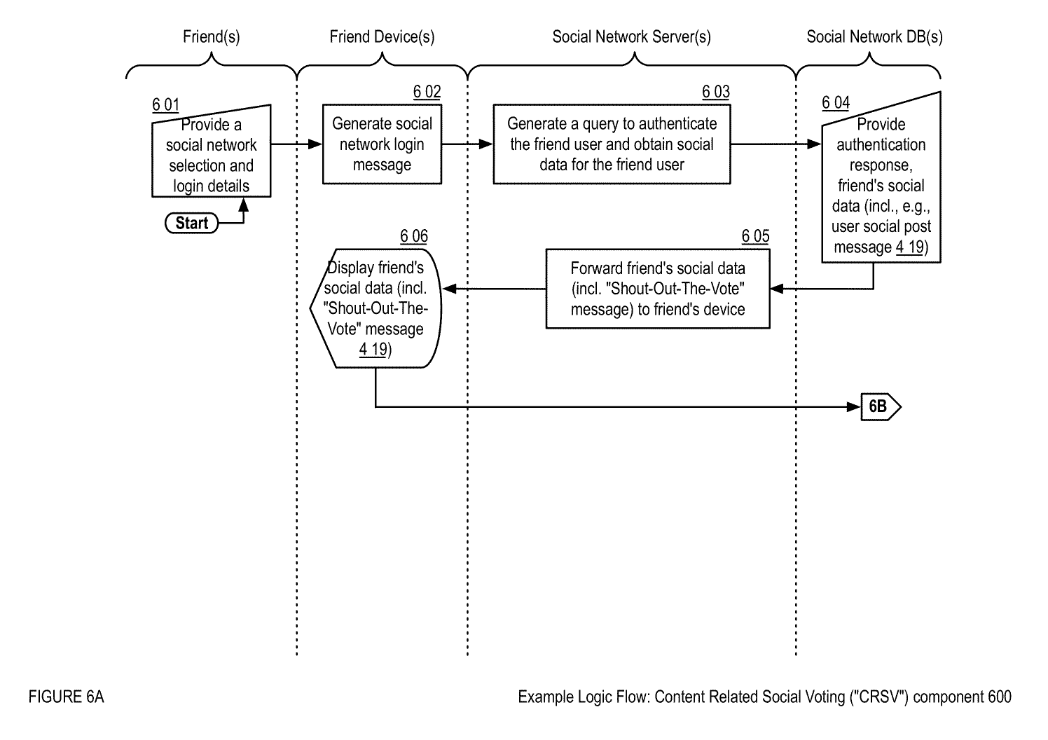

FIGS. 6A-B show logic flow diagrams illustrating example aspects of content related social voting in some embodiments of the CRVV, e.g., a Content Related Social Voting (“CRSV”) component 600. With reference to FIG. 6A, in some embodiments, others (e.g., a voting user's friends) may view the user's Shout Out The Vote™. For example, a friend may utilize a friend device to view social data from a social network server. The friend may provide social network/site selection and login inputs to the friend device, 601. The friend device may generate a social network login message using the user selection-login inputs, 602. The friend device may send the generated social network login message to social network server. The social network server may parse the received social network login message, and extract user authentication data from the message. The social network server may query a social network database to determine whether the user is authenticated, 603. In response, the social network database may provide a user authentication response 604, and if authenticated, may also provide social data for presentation to the friend including the Shout Out The Vote™ message from a voting user (see, e.g., FIG. 3C, elements 333-338) who is socially related to the friend. The social network server may provide the Shout Out The Vote™ message from the user to the friend device, 605. The friend device may present the user's Shout Out The Vote™ message to the friend, 606.

With reference to FIG. 6B, in some embodiments, the friend may cast votes with the voting system, in the process becoming a user of the voting system, as well as being considered a “recruit” of the original user by the voting system. For example, the friend may provide a voting input into the friend device, 607. In response to the friend's voting input, the friend device may generate a voting message, 608, and provide the voting message to the secure vote server.

In some embodiments, the secure vote server may parse the voting message, and extract data on the friend and the friend's vote from the voting message. Using the extracted data, the secure vote server may determine whether the friend vote can be accepted. For example, the secure vote server may determine whether the vote data is valid, whether the vote was submitted within the appropriate time window for the particular media related to the user's vote, whether the friend has sufficient permissions to cast the particular vote, or the like. Upon determining that the friend vote can be accepted, the secure vote server may generate a friend vote data query, and provide the voting page query to a vote database. In response to the query, the vote database may provide a friend vote data record. The secure vote server may parse, the friend vote data record, and extract the data included in the friend vote data record. Using the data extracted from the friend vote data record and the voting message, the secure vote server may generate an updated friend vote data record.

In some embodiments, the voting system may reward its users for recruiting other users by assigning credits, points, etc., for each recruit the user brings to the voting system. The secure vote server may parse the vote message 609, and extract any tokens identifying one or more recruiting users or user groups who (were in the chain of users or groups that) recruited the friend to vote with the voting system. Using the extracted token, the secure vote server may query a vote database for a user ID of the recruiting users or groups involved in recruiting the friend to the voting system, 610. In response, the vote database may provide a list of recruiting users and groups, 611. In some embodiments, for each recruiting user, the secure vote server may identify a list of groups affiliated to the user. In addition to the (independent) recruiting groups, the secure vote server may reward (dependent) groups affiliated to recruiting users, in some embodiments. For example, the secure vote server may query the vote database for user groups affiliated to each recruiting user that can be rewarded for the user's efforts in recruiting the friend to the voting system, 612. For example, a subset of the user's affiliated groups may be rewarded depending on the user's preferences as to which of the user's affiliated groups should be rewarded, the membership level of the user within each of the user's affiliated groups, or the like. The vote database may provide a list of the user's affiliated groups that can be so rewarded in response to the creditable user group query, 613.

In some embodiments, using the above data, the secure vote server may determine, for each identified recruiting or recruiter-affiliated user or group, a type and amount of credit to assign for recruiting the friend to the voting system, 614. In various embodiments, the secure vote server may utilize a range of simple or complex algorithms to determine an amount or type of credit to be awarded. For example, the secure vote server may award one credit for each recruited vote to each of the users and/or groups affiliated with the recruited vote, wherein the type of credit may be determined based on the media program type, or type of entity (e.g., user, group) to which the credit is being awarded. As another example, the reward algorithm may utilize tiers of rewards (e.g., providing 1 credit each of the first 5 votes, then 2 votes for the next 10, then 3 for the next 50, and so on). In some algorithms, the reward algorithm may determine a distance to the recruited vote. For example, a first user who recruits a second user directly may be considered to be at a distance of 1 from the second user. However, if the second user then recruits a third user, the first user may be considered to be at a distance of 2 from the recruited third user. The credit awarded to a recruiting user may then depend on the distance between the recruiting user and the recruited user. The weight by which the amount credited varies may depend linearly on the distance (multiplier x), exponentially on the distance (multiplier e^{x}), inverse exponentially on the distance (multiplier [1−e^{-x}]), etc. In some algorithms, the secure vote server may adaptively modify the amount of credit awarded for recruiting a vote, based on factors such as, but not limited to: total (for the user, or aggregated across users) number of votes cast, total (for the user, or aggregated across users) amount of credits already assigned, total number of users consuming the media related to the vote (e.g., as determined from ratings such as Nielsen ratings), rates of vote casting (for the user, or aggregated across users, for the specific media program, or assessed across media programs), or the like.

The secure vote server may also determine the position of each user or group in each leaderboard in which they may appear. In some embodiments, the secure vote server may determine whether any of the users or groups qualify for an award (e.g., virtual currency, cash prize, badges, publicity, etc.). For example, the redeemable currency may be an actual or virtual currency that may be redeemed at site such as PayPal™. In various embodiments, a wide range of awards similar to the above may be determined by the secure vote server for each of the users or groups who can be rewarded for assisting in recruiting the friend to the voting system. The secure vote server may store the updated credits, leaderboard, awards and other data to the vote database, 615. In some embodiments, the secure vote server may redirect the friend to the Shout Out The Vote process, such as described above with reference to FIG. 4C. The secure voter server may generate and provide a Shout Out The Vote™ request to the friend device, 616, which may in turn present the Shout Out The Vote™ Request to the friend (who may become equivalent to user in FIG. 4C in some embodiments), 617.

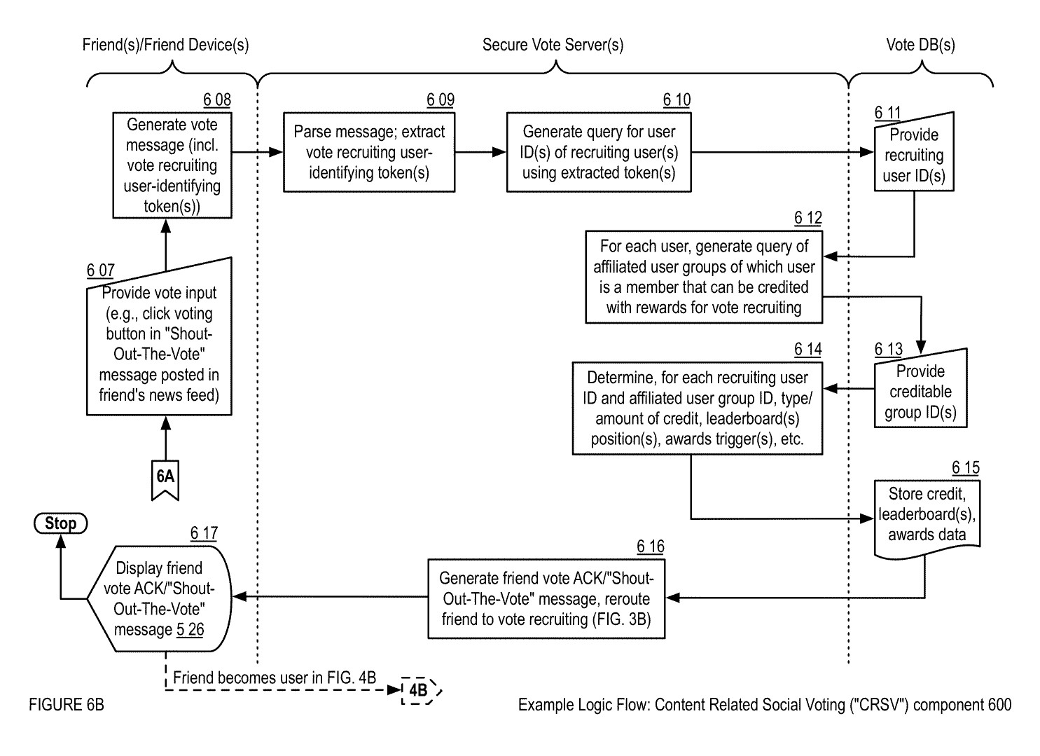

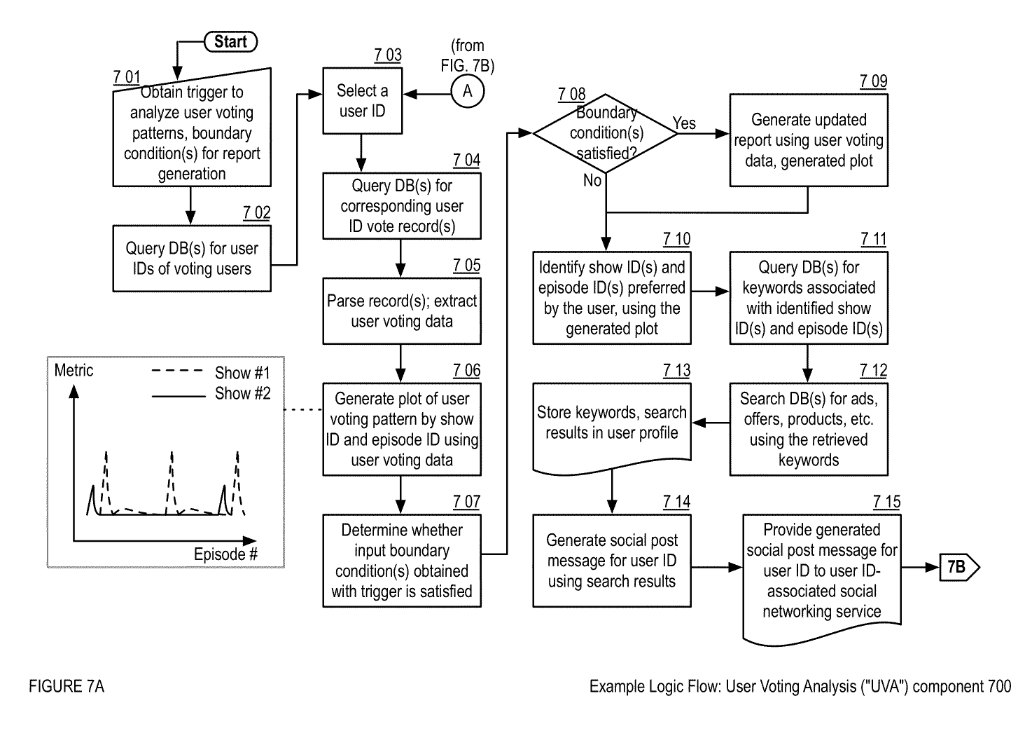

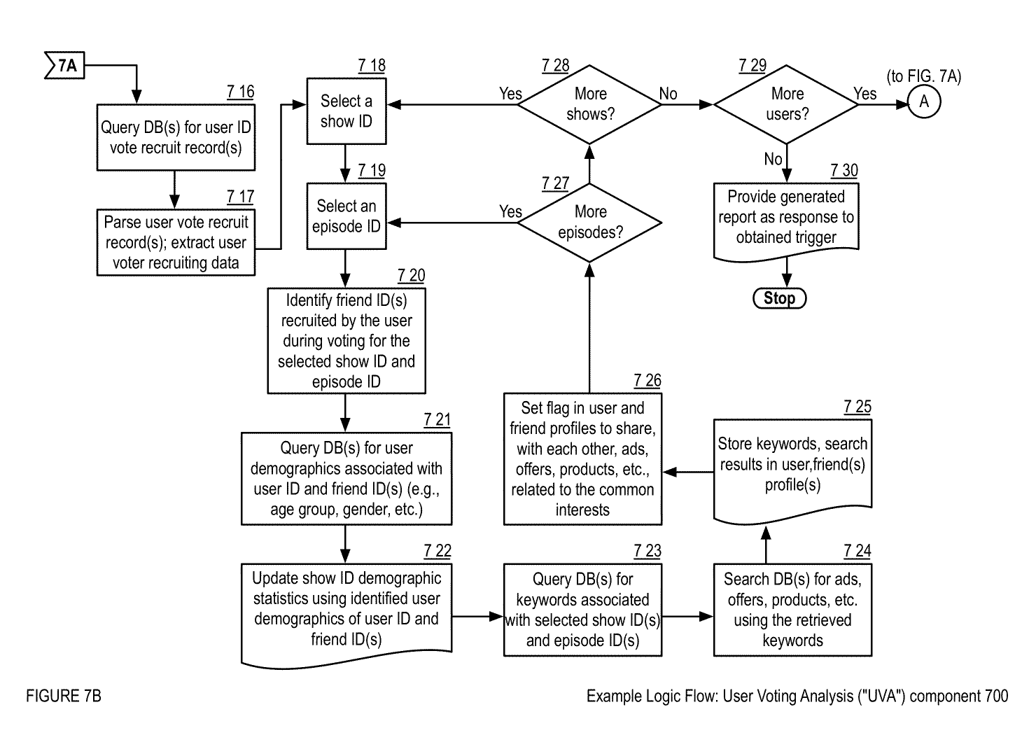

FIGS. 7A-B show logic flow diagrams illustrating example aspects of analyzing user votes in some embodiments of the CRVV, e.g., a User Voting Analysis (“UVA”) component 700. In some embodiments, the voting system may analyze voting patterns of users, and recruiting patterns of the users. The voting system may utilize the voting and recruiting patterns to identify demographics and preferences of various users, which may be used in tailoring the broadcast media content to further drive media consumption. For example, the voting and recruiting patterns may be used for targeted advertisements, programming content selection, reality TV contestant selection, re-run content selection, selection of interactive programming elements, informing new production of future shows/episodes, adaptively modifying the voting process and rewards mechanisms of the voting system, identifying social mechanisms for increasing media consumption, and various other optimizations in various embodiments of the CRVV.

With reference to FIG. 7A, in some embodiments, the CRVV may obtain a trigger to analyze voting patterns, 701, and generate a report. The CRVV may obtain the boundary parameters for user behavior that affects the report. For example, the boundary conditions may include: specific geographic locations of users, specific voting periods, specific social networks using which voters are recruited, specific voting times, specific shows, episodes or events that are the subject of the voter-consumed media, specific contestants/participants/actors portrayed within the media, or the like. The CRVV may query a database for user IDs of voting/recruiting users or groups, 702. In some embodiments, the CRVV may process each of the IDs retrieved from the database. For example, the CRVV may select one of the retrieved IDs, 703. The CRVV may query the database for voting records corresponding to the selected ID, 704. The database may provide voting records corresponding to the queried ID. The CRVV may parse the obtained voting data record, and extract voting data associated with the ID, 705. Using the extracted voting data, the CRVV may generate a plot of user voting patterns across various episodes of different shows (see, e.g., inset in FIG. 7A), 706. In alternate embodiments, the CRVV may generate plots representing user voting across locations, times, or other variables represented in the voting data. In some embodiments, the CRVV may determine whether the voting data of the selected ID satisfies the boundary conditions 701 input into the CRVV for the report generation, 707. If the CRVV determines that the boundary conditions are satisfied, 708 (option “Yes”), the CRVV may utilize the voting data of the ID to generate an updated report, 709. In some embodiments, the CRVV may identify 710 show ID(s), episode ID(s), or the like, that are preferred by the user or group associated with the selected ID, using the plots generated in 706. Using the identified show, episode, actors, or other ID(s), the CRVV may query a database for keywords associated with the user's preferences, 711. Using the keywords retrieved from the database, in some embodiments, the CRVV may search databases for ads, offers, products, or the like related to the keywords, 712. The CRVV may store the keywords and obtained search results in a database for later use, 713. In some embodiments, the CRVV may generate a social post using the ads, offers, products or the like identified as being relevant to the ID, 714, and provide the generated social post message for the selected ID to social networking services associated with the ID, 715.

In some embodiments, the CRVV may analyze recruiting patterns of a voter as part of the report generation. The CRVV may query a database for recruiting records related to the selected user ID, 716. The CRVV may parse the obtained recruiting records, and extract user/group voter recruiting data, 717. In some embodiments, the CRVV may analyze demographics of voter associated with each instance of media content. For example, the CRVV may select a show ID, 718. The CRVV may analyze each episode of the selected show ID. The CRVV may select an episode ID, 719, and identify IDs of friends that were recruited to vote by the user in the selected episode ID and show ID, 720. The CRVV may identify demographical information (e.g., age group, gender, political leanings, or the like) of the friend IDs and the user IDs, by querying a database for profile information on the friend IDs and user ID, 721. Using the demographical information for the friend IDs and user ID, the CRVV may update the demographical statistics for the selected show ID and episode ID, 722. In some embodiments, the CRVV may query a database for keywords associated with the selected show ID and episode ID, 723. Using the keywords, the CRVV may search for ads, offers, products, coupons, or the like, that may be of interest to the user ID and friend ID, 724. The CRVV may store the keywords and search results in the profiles of the user ID and friend IDs, 725. In some embodiments, the profiles for the user ID and friend ID may include a “common interest” field. The CRVV may assign the show ID, episode ID, keywords and search results as a common interest among the user ID and friend IDs, 726. The CRVV may perform such an analysis for all episodes of a show (see 727), and all shows or media content available (see 728). Further, in some embodiments, the CRVV may perform the above analysis for all users and groups included in the voting system (see 729). Upon completion of the analysis for all the required users, media, shows, episodes and friends, the CRVV may generate a report satisfying the input boundary conditions using the data mined as described above, and provide the report as an output, 730.

### CRVV Controller

FIG. 8 shows a block diagram illustrating embodiments of a CRVV controller 801. In this embodiment, the CRVV controller 801 may serve to aggregate, process, store, search, serve, identify, instruct, generate, match, or facilitate interactions with a computer through various technologies, or other related data.

Typically, users, e.g., 833a, which may be people or other systems, may engage information technology systems (e.g., computers) to facilitate information processing. In one embodiment, the CRVV controller 801 may be connected to or communicate with entities such as, but not limited to: one or more users from user input devices 811; peripheral devices 812; an optional cryptographic processor device 828; or a communications network 813. The CRVV controller 801 may also be connected to or communicate with users, e.g., 833a, who are operating client device(s), e.g., 833b, including, but not limited to, personal computer(s), server(s) or various mobile device(s) such as cellular telephone(s), smartphone(s) (e.g., iPhone®, Blackberry®, Android OS-based phones etc.), tablet computer(s) (e.g., Apple iPad™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), or the like. Such client device(s) may communicate with the CRVV controller via communications network 813, which may include Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another. The CRVV controller may utilize input output interfaces (I/O) 808, storage interfaces 809, network interfaces 810, or the like to engage in such communication with people or external systems.

In turn, computers employ processors, such as one or more microprocessors, to process information. Example microprocessors include AMD's Athlon, Duron or Opteron; ARM's application, embedded and secure processors; IBM or Motorola's DragonBall and PowerPC; IBM's and Sony's Cell processor; Intel's Celeron, Core (2) Duo, Itanium, Pentium, Xeon, XScale etc. Should processing requirements dictate a greater amount of speed or capacity, distributed processors (e.g., Distributed CRVV), mainframe, multi-core, parallel, or super-computer architectures may similarly be employed. In one embodiment, the CRVV controller 801 may be based on computer systems that may comprise, but are not limited to, components such as: a computer systemization 802 connected to memory 829. A computer systemization 802 may comprise a system clock 830, processor(s) 803, a memory 829 (e.g., a read only memory (ROM) 806, a random access memory (RAM) 805, etc.), or an interface bus 807, and most frequently, although not necessarily, are all interconnected or communicating through a system bus 804 on one or more (mother)board(s) 802 having conductive or otherwise transportive circuit pathways through which instructions (e.g., binary encoded signals) may travel to effectuate communications, operations, storage, etc. The computer systemization may be connected to a power source 886; e.g., optionally the power source may be internal. Optionally, a cryptographic processor 826 or transceivers (e.g., ICs) 874 may be connected to the system bus. In another embodiment, the cryptographic processor or transceivers may be connected as either internal or external peripheral devices 812 via the cryptographic processor interface 827 within the interface bus. In turn, the transceivers may be connected to antenna(s) 875, thereby effectuating wireless transmission and reception.

Processors may use communicative circuits to pass binary encoded signals acting as instructions to enable various operations. These instructions may be stored in batches as programs, in processor-accessible memory 829 (e.g., registers, cache memory, random access memory, etc.). Examples of memory include on-chip CPU memory (e.g., registers), paper punch tape or paper punch card mechanisms, ROM 806, RAM 805, storage device 814 such as a drum; a (fixed or removable) magnetic disk drive; a magneto-optical drive; an optical drive (i.e., Blueray, CD ROM/RAM/Recordable (R)/ReWritable (RW), DVD R/RW, etc.); an array of devices (e.g., Redundant Array of Independent Disks (RAID)); solid state memory devices (USB memory, solid state drives (SSD), etc.), or the like.

The memory 829 may contain a collection of program or database components or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the CRVV component(s) 835; or the like (i.e., collectively a component collection). These components may be stored and accessed from the storage devices or from storage devices accessible through an interface bus.

The operating system component 815 is an executable program component facilitating the operation of the CRVV controller. Example operating systems include Apple Macintosh OS X, iOS 5, Unix, Linux distributions (e.g., Red Hat, Ubuntu, etc.), Microsoft Windows 7 (desktop or mobile), Google Android, or the like. The operating system may enable the interaction with communications networks, data, I/O, peripheral devices, program components, memory, user input devices, or the like.

An information server component 816 is a stored program component such as a conventional Internet information server (e.g., Apache Software Foundation's Apache, Microsoft's Internet Information Server, etc.). The information server may allow for the execution of program components through facilities such as Active Server Page (ASP), FLASH, Java, JavaScript, Practical Extraction Report Language (PERL), Hypertext Pre-Processor (PHP), or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America (AOL) Instant Messenger (AIM), open XML-based Extensible Messaging and Presence Protocol (XMPP) (e.g., Jabber), or the like.

A user interface component 817 is a stored program component that may allow for the display, execution, interaction, manipulation, or operation of program components or system facilities through textual or graphical facilities. The user interface may be a conventional graphic user interface as provided by, with, or atop operating systems or operating environments such as already discussed. Computer interaction interface elements such as check boxes, cursors, menus, scrollers, and windows (collectively and commonly referred to as widgets) may facilitate the access, capabilities, operation, and display of data and computer hardware and operating system resources, and status. Graphical user interfaces (GUIs) may provide features for accessing and displaying information graphically to users.

A Web browser component 818 may be a conventional hypertext viewing application such as Apple Safari, Google Chrome, Mozilla Firefox, Microsoft Internet Explorer or the like. Secure Web browsing may be supplied with 128 bit (or greater) encryption by way of HTTPS, SSL, or the like. Web browsers allowing for the execution of program components through facilities such as ActiveX, AJAX, (D)HTML, FLASH, Java, JavaScript, web browser plug-in APIs (e.g., FireFox, Safari Plug-in, or the like APIs), or the like. Web browsers and like information access tools may be integrated into PDAs, cellular telephones, or other mobile devices. A mail server component 821 may be a conventional Internet mail server such as, but not limited to sendmail, Microsoft Exchange, or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), or the like. A mail client component 822 may be a conventional mail viewing application such as Apple Mail, Microsoft Outlook, or the like. Mail clients may support a number of transfer protocols, such as: IMAP, Microsoft Exchange, POPS, SMTP, or the like.

A cryptographic server component 820 may allow for expedition of encryption or decryption requests by the cryptographic component; however, the cryptographic component, alternatively, may run on a conventional CPU. The cryptographic component allows for encryption of incoming or outgoing communications

The CRVV database component 819 may be embodied in a database and its stored data. The database may be a conventional, fault tolerant, relational, scalable, secure database such as Oracle or Sybase. Alternatively, the CRVV database may be implemented using various standard data-structures, such as an array, hash, (linked) list, struct, structured text file (e.g., XML), table, or the like. Such data-structures may be stored in memory or in (structured) files. In another alternative, an object-oriented database may be used, such as Frontier, ObjectStore, Poet, Zope, or the like. Object databases can include a number of object collections that are grouped or linked together by common attributes; they may be related to other object collections by some common attributes. Portions of databases, e.g., tables, may be exported or imported and thus decentralized or integrated.

In one embodiment, the database component 819 includes several tables 819a-k. A Users table 819a may include fields such as, but not limited to: user_id, ssn, dob, first_name, last_name, age, state, address_firstline, address_secondline, zipcode, devices_list, contact_info, contact_type, alt contact_info, alt contact_type, or the like. A Devices table 819b may include fields such as, but not limited to: user_id, device_id, device_ip, device_type, device_model, operating_system, os_version, app_installed_flag, or the like. An Apps table 819c may include fields such as, but not limited to: app_ID, app_name, app_type, OS_compatibilities_list, version, timestamp, developer_ID, dependency_graph_list, or the like. An Accounts table 819d may include fields such as, but not limited to: user_id, account_id, account_name, member_list, leaderboard_membership_list, voter_scoring_matrix, or the like. A Social Graph table 819e may include fields such as, but not limited to: user_id, friend_id_list, friend_type_list, friend_weight_list, or the like. A Products table 819f may include fields such as, but not limited to: purchase_details_list, num_products, products_list, product_type, product_params_list, product_title, product summary, inventory_quantity, merchant_id, merchant_name, merchant_auth_key, or the like. An Offers table 819g may include fields such as, but not limited to: offer_id, offer_name, offer_detail_list, offer_creator, timestamp, last_modified, expiry, or the like. A Leaderboard table 819h may include fields such as, but not limited to: leaderboard_id, leaderboard_name, leaderboard_type, leaderboard_rules_list, leaderboard_membership_list, or the like. A Voting Records table 819i may include fields such as, but not limited to: user_id, show_id, episode_is, show_type, vote_type, vote_selection, timestamp, affiliate_group_list, voting_histogram_list, token_id, or the like. A Behavior Data table 819j may include fields such as, but not limited to: user_id, activity_type, activity_value, timestamp, game_id, game_name, game_type, game_genre, or the like. An Analytics table 819k may include fields such as, but not limited to: user_id, voting_pattern_graph_list, recruiting_pattern_graph_list, histogram_list, or the like.

The CRVV component 835 may transform requests for votes in displayed consumable media via CRVV components into rewards for voter recruiting through social networking, or the like and use of the CRVV. In one embodiment, the CRVV component 835 takes inputs (e.g., consumable media 311, voting request input 312, voting page 316, voting input 320, user vote data record 325, social network(s) selection-login input(s) 332, user social graph data 336, social network selection-login input 511, user authentication response, social data 515, vote input 519, recruiting user ID 523, user group ID 525, or the like) etc., and transforms the inputs via various components (e.g., SVR 841, CRSV 842, UVA 843, or the like), into outputs (e.g., voting page get request 314, voting page 317, user vote, user vote recruit data record(s) 328, user vote ACK, “Shout Out The Vote” request 329-330, social post message(s) 338, social post notification 339-340, social network login message 513, social data 516-517, vote message 520, credit, leaderboard, awards data 527, friend vote ACK 528-529, or the like). The CRVV component enabling access of information between nodes may be developed by employing standard development tools and languages such as C (++), C# or .NET, database adapters, CGI scripts, Java, JavaScript, PHP, SQL commands, or the like. The structure or operation of any of the CRVV node controller components may be combined, consolidated, or distributed in any number of ways to facilitate development or deployment. Similarly, the component collection may be combined in any number of ways to facilitate deployment or development.

If CRVV components are discrete, separate, and/or external to one another, then communicating, obtaining, and/or providing (e.g., including transmitting, granting access, allowing transmission, etc.) data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http://... Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the CRVV controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end
of message
do {
  $input = “”;
  $input = socket_read($client, 1024);
  $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation and other parser implementations, all of which are hereby expressly incorporated by reference:

```
[1] http://www.xav.com/perl/site/lib/SOAP/Parser.html
[2] http://publib.boulder.ibm.com/infocenter/tivihelp/v2r1/index.jsp?topic=
  /com.ibm.IBMDI.doc/referenceguide295.htm
[3] http://publib.boulder.ibm.com/infocenter/tivihelp/v2r1/index.jsp?topic=/
  com.ibm.IBMDI.doc/referenceguide259.htm
```

In order to address various issues and advance the art, the entirety of this application for CONTENT RELATED VIEWER VOTING APPARATUS, METHOD AND SYSTEM (including the Cover Page, Title, Headings, Field, Background, Summary, Brief Description of the Drawings, Detailed Description, Claims, Abstract, Figures, or otherwise) shows by way of illustration various embodiments in which the claimed innovations may be practiced. The advantages and features of the application are of a representative sample of embodiments only, and are not exhaustive or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural or topological modifications may be made without departing from the scope or spirit of the disclosure. As such, all examples or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical or topological structure of any combination of any program components (a component collection), other components or any present feature sets as described in the figures or throughout are not limited to a fixed operating order or arrangement, but rather, any disclosed order is exemplary and all equivalents, regardless of order, are contemplated by the disclosure. Furthermore, it is to be understood that such features are not limited to serial execution, but rather, any number of threads, processes, services, servers, or the like that may execute asynchronously, concurrently, in parallel, simultaneously, synchronously, or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, or the like thereof. As such, it should be understood that advantages, embodiments, examples, functional, features, logical, operational, organizational, structural, topological, or other aspects of the disclosure are not to be considered limitations on the disclosure as defined by the claims or limitations on equivalents to the claims. It is to be understood that, depending on the particular needs or characteristics of a CRVV individual or enterprise user, database configuration or relational model, data type, data transmission or network framework, syntax structure, or the like, various embodiments of the CRVV may be implemented that enable a great deal of flexibility and customization. For example, aspects of the CRVV may be adapted for user behavior analysis, content rating systems, or the like. While various embodiments and discussions of the CRVV have been directed to consumer engagement, however, it is to be understood that the embodiments described herein may be readily configured or customized for a wide variety of other applications or implementations.

What is claimed is:

1. A computer-implemented method for facilitating content-related viewer voting, comprising:
receiving a request from a registered user to vote in a content-related electronic voting opportunity;
transmitting, to the user, a voting opportunity page having at least one voting question in at least one question category and an expiration time;
recording a content-related vote from the user, based on providing the voting opportunity page;
granting the user with a opportunity to share the content-related vote from the user and the voting opportunity;
generating a social vote post message comprising a token identifying the user;
receiving a vote from a peer of the user who viewed the social vote post message; and
correlating the vote of the peer with the recorded content-related vote from the user, to create a recruited vote total attributable to the user for each voting question.

2. The method of claim 1, wherein the voting question concerns an event portrayed within content provided to the user.

3. The method of claim 2, wherein the content is a video stream accessed by the user via a network.

4. The method of claim 1, wherein the social vote post message provides a single-click voting opportunity for the peer.

5. The method of claim 1, wherein the recruited vote total attributable to the user varies depending on whether the peer is a user registered to vote in the content-related electronic voting opportunity.

6. The method of claim 1, further comprising:
aggregating votes obtained from peers identified via discrete social post messages;
analyzing, statistically, the aggregated votes obtained from the peers;
generating a report based on the statistical analysis; and
transmitting the generated report to an entity controlling recording of content related votes.

7. The method of claim 6, further comprising:
identifying a promotion targeted to the peers, based on the statistical analysis; and
transmitting the identified promotion to the peers.

8. A system for content-related viewer voting, comprising:
a processor; and
a memory disposed in communication with the processor and storing processor-executable instructions to:
obtain a content-related vote for a user;
provide an indication for the user to publish the content-related vote;
obtain a user selection of an publication to which to publish the content-related vote;
generate, via the processor, a resource locator including a token uniquely associated with the user; and
provide the content-related vote and the generated resource locator, for publishing to the user-selected publication.

9. The system of claim 8, the memory further storing instructions to:
obtain a content-related peer vote message for a peer user, the content-related peer vote message including the token uniquely associated with the user;
determine that a reward should be calculated for the user based on the inclusion of the token uniquely associated with the user in the obtained content-related peer vote for the peer user;
calculate a reward for the user, for recruiting the peer user for whom the content-related peer vote was obtained; and
provide an indication of the calculated reward for the user.

10. The system of claim 9, wherein the reward is in exchange-tradable currency.

11. The system of claim 9, the memory further storing instructions to:
determine a ranking of the user in a virtual leaderboard by incorporating the calculated reward for the user into a leaderboard points total;
identifying a virtual badge to be awarded to the user based on the determined ranking; and
providing a notification to the user of the identified virtual badge.

12. The system of claim 9, the memory further storing instructions to:
identify a group affiliated with the user; and
calculate a reward for the affiliated group, for recruiting the peer user for whom the content-related peer vote was obtained.

13. The system of claim 12, the memory further storing instructions to:
determine a ranking of the affiliated group in a virtual leaderboard; and
provide an indication of the ranking of the affiliated group in the virtual leaderboard.

14. The system of claim 12, wherein the virtual leaderboard ranks at a user, in addition to the affiliated group.

15. A computer-readable tangible medium storing computer-executable content-related viewer voting instructions to:
obtain a content-related vote for a user;
provide an indication to publish the content-related vote;
obtain a selection of an publication to which to publish the content-related vote;
generate a token associated with the user for publishing the content-related vote; and
provide the content-related vote and the generated token, for publication to the selected publication.

16. The medium of claim 15, further storing instructions to:
aggregate content-related votes recruited via the publication to the selected publication; and
analyze the aggregated content-related votes.

17. The medium of claim 15, further storing instructions to:
calculate a per-impression advertising value based on at least one of:
an analysis of aggregated content-related votes; and
a comparison of relative performances of a plurality of advertising campaigns.

18. The medium of claim 16, further storing instructions to:
determine, based on the analysis of the aggregated content-related votes, an outcome to be portrayed in consumable media content related to the content-related vote.

19. The medium of claim 17, further storing instructions to:
compare relative performances of a plurality of advertising campaigns, based on the analysis of the aggregated content-related votes.

20. The medium of claim 15, wherein the content-related vote is cast online.
